(19) United States
(12) Patent Application Publication
(10) Pub. No.: US 2025/0009081 A1
(43) Pub. Date: Jan. 9, 2025

(54) WEARABLE DEVICE AND HEAD STRAP MODULE

(71) Applicant: HTC Corporation, Taoyuan City (TW)

(72) Inventors: Chien Min Lin, Taoyuan City (TW); Chih-Yao Chang, Taoyuan City (TW); Tsen-Wei Kung, Taoyuan City (TW); Chung-Ju Wu, Taoyuan City (TW); Tsung-Hua Yang, Taoyuan City (TW)

(73) Assignee: HTC Corporation, Taoyuan City (TW)

(21) Appl. No.: 18/619,040

(22) Filed: Mar. 27, 2024

Related U.S. Application Data
(60) Provisional application No. 63/524,703, filed on Jul. 3, 2023.

(51) Int. Cl. A44C 5/18; G06F 1/16

(52) U.S. Cl. CPC A44C 5/18; G06F 1/163

(57) ABSTRACT

A wearable device includes a host and a head strap module. The host has a pair of host connecting ends. The head strap module includes a head strap body and a pair of strengthening assemblies. The head strap body has a pair of head strap connecting ends. The pair of head strap connecting ends are respectively detachably assembled to the pair of host connecting ends. Each of the pair of strengthening assemblies has an outer cover and an inner cover. The outer cover and the corresponding inner cover are connected to each other to jointly cover and hold the corresponding host connecting end and the corresponding head strap connecting end. In addition, a head strap module applied to a wearable device is also provided.

### CROSS-REFERENCE TO RELATED APPLICATION

This application claims the priority benefit of U.S. provisional application Ser. No. 63/524,703, filed on Jul. 3, 2023. The entirety of the above-mentioned patent application is hereby incorporated by reference herein and made a part of this specification.

### BACKGROUND

### Technical Field

The present application relates to a device and a head strap module, and in particular to a wearable device and a head strap module.

### Description of Related Art

As the technology industry becomes increasingly developed, the types, functions of use, and methods of use of display devices are becoming more diverse, and wearable display devices that may be worn directly on the user's body have also emerged accordingly. There are many types of head-mounted display devices. Take glasses-type head-mounted display devices as an example. After a user wears this type of display device, in addition to seeing three-dimensional images, the images are also changed as the user's head turns, providing the user with a more immersive experience. However, when the user is playing games and the movements are too intense, a pair of temple legs of a glasses-type head-mounted display device may not provide sufficient clamping force. Therefore, providing one additional head strap module assembled to the ends of the temple legs may reduce the risk of the glasses-type head-mounted display device falling.

### SUMMARY

The present application provides a wearable device with a relatively stable assembly connection between the host and the head strap module thereof.

The present application provides a head strap module applied to a wearable device and having a relatively stable assembly connection with the host of the wearable device.

A wearable device of an embodiment of the present application includes a host and a head strap module. Two opposite sides of the host have a first host connecting end and a second host connecting end respectively. The head strap module includes a head strap body, a first strengthening assembly, and a second strengthening assembly. Two opposite sides of the head strap body have a first head strap connecting end and a second head strap connecting end respectively. The first head strap connecting end and the second head strap connecting end are detachably assembled to the first host connecting end and the second host connecting end respectively. The first strengthening assembly has a first outer cover and a first inner cover. The first outer cover and the first inner cover are connected to each other to jointly cover and hold the first host connecting end and the first head strap connecting end. The second strengthening assembly has a second outer cover and a second inner cover. The second outer cover and the second inner cover are connected to each other to jointly cover and hold the second host connecting end and the second head strap connecting end.

A head strap module of an embodiment of the present application is applied to a wearable device. The wearable device includes a host. Two opposite sides of the host have a first host connecting end and a second host connecting end respectively. The head strap module includes a head strap body, a first strengthening assembly, and a second strengthening assembly. Two opposite sides of the head strap body have a first head strap connecting end and a second head strap connecting end respectively. The first head strap connecting end and the second head strap connecting end are detachably assembled to the first host connecting end and the second host connecting end respectively. The first strengthening assembly has a first outer cover and a first inner cover. The first outer cover and the first inner cover are connected to each other to jointly cover and hold the first host connecting end and the first head strap connecting end. The second strengthening assembly has a second outer cover and a second inner cover. The second outer cover and the second inner cover are connected to each other to jointly cover and hold the second host connecting end and the second head strap connecting end.

Based on the above, in the above embodiments of the present application, the strengthening assemblies of the head strap module cover and hold the corresponding host connecting end and head strap connecting end, so that there is a more stable assembly connection between the host and the head strap module.

### BRIEF DESCRIPTION OF THE DRAWINGS

FIG. 1A to FIG. 1C illustrate an assembly process of a wearable device of an embodiment of the invention.

FIG. 2A to FIG. 2C illustrate the assembly process of a first host connecting end, a first head strap connecting end, and a first strengthening assembly of a wearable device.

FIG. 3A to FIG. 3C illustrate the assembly process of a second host connecting end, a second head strap connecting end, and a second strengthening assembly of a wearable device.

FIG. 4 is a schematic diagram of the wearable device of FIG. 1C after being equipped with a head strap.

### DESCRIPTION OF THE EMBODIMENTS

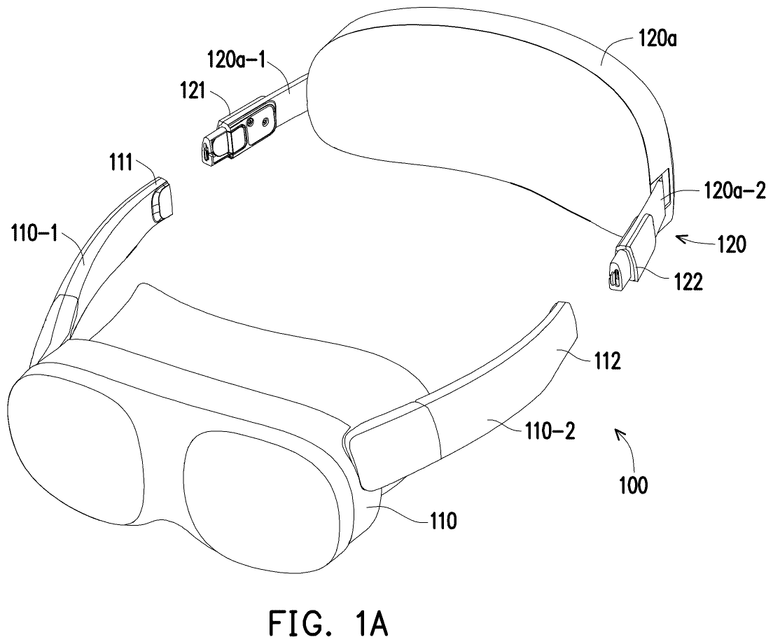

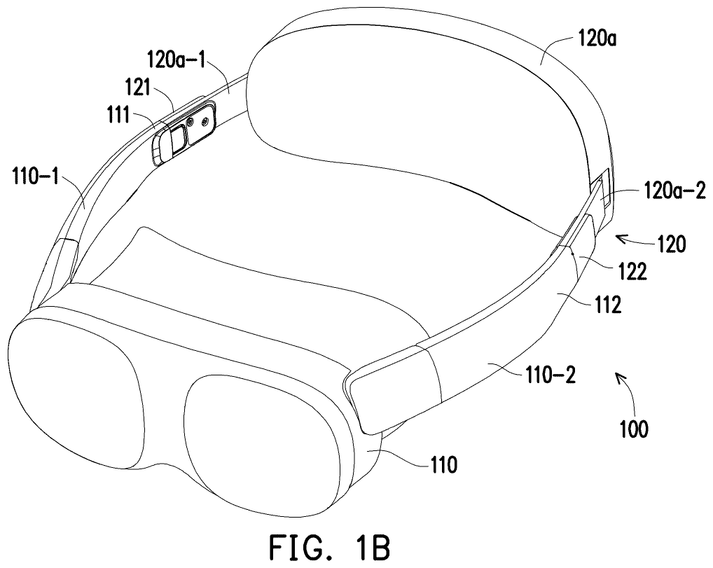

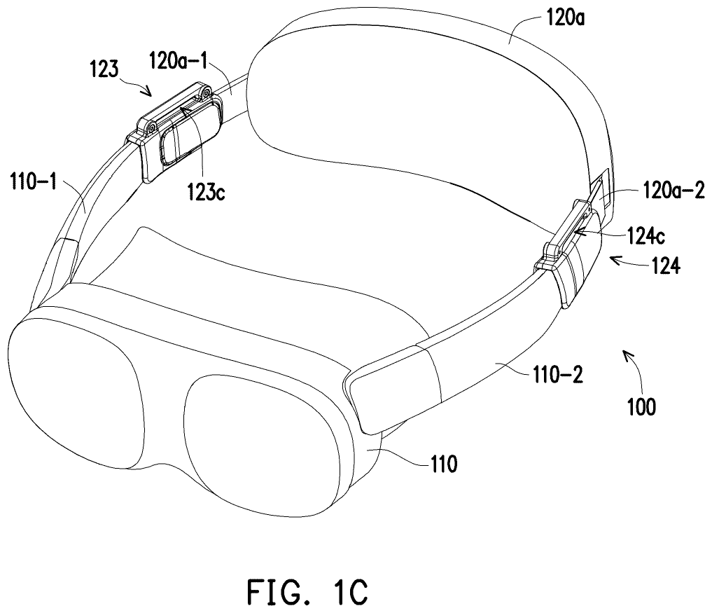

Please refer to FIG. 1A and FIG. 1B. In the present embodiment, a wearable device 100 includes a host 110 and a head strap module 120. The host 110 is a head-mounted display and may be applied in a field such as virtual reality system, augmented reality system, or mixed reality system. The host 110 may include a member such as an optical system and a protective shell, and may be provided with a display or be suitable for placing a display. The display may be a built-in display or an external portable display (such as a smart phone, etc.), but not limited thereto. The optical system includes an optical element used to change the optical path of the display, such as a lens, a light guide element, or a prism.

In the present embodiment, two opposite sides of the host 110 have a first host connecting end 111 and a second host connecting end 112 respectively. The head strap module 120 includes a head strap body 120a. Two opposite sides of the head strap body 120a have a first head strap connecting end 121 and a second head strap connecting end 122 respectively. The first head strap connecting end 121 and the second head strap connecting end 122 are detachably assembled to the first host connecting end 111 and the second host connecting end 112 respectively.

In the present embodiment, two opposite sides of the host 110 may have a first bracket 110-1 and a second bracket 110-2 respectively, and the ends of the first bracket 110-1 and the second bracket 110-2 may serve as the first host connecting end 111 and the second host connecting end 112 respectively. Moreover, two opposite sides of the head strap body 120a may have a first strap body 120a-1 and a second strap body 120a-2 respectively, and the ends of the first strap body 120a-1 and the second strap body 120a-2 may serve as the first head strap connecting end 121 and the second head strap connecting end 122 respectively.

In more detail, in the present embodiment, the head strap module 120 further includes an adjustment mechanism (not shown) disposed in the head strap body 120a. An adjustment mechanism 128c is disposed at the overlap of the first strap body 120a-1 and the second strap body 120a-2 to adjust the overlap length of the first strap body 120a-1 and the second strap body 120a-2. In other words, after the host 110 and the head strap module 120 are combined, by adjusting the overlap length of the first strap body 120a-1 and the second strap body 120a-2, users with different body shapes may wear the wearable device 100 comfortably and securely.

Please refer to FIG. 1B and FIG. 1C. In the present embodiment, the head strap module 120 further includes a first strengthening assembly 123. The first strengthening assembly 123 has a first outer cover 123a and a first inner cover 123b. The first outer cover 123a and the first inner cover 123b are connected to each other to jointly cover and hold the first host connecting end 111 and the first head strap connecting end 121. Therefore, the first strengthening assembly 123 provides structural reinforcement, so that the assembly connection between the first host connecting end 111 of the host 110 and the first head strap connecting end 121 of the head strap body 120a is more stable.

In addition, the head strap module 120 further includes a second strengthening assembly 124. The second strengthening assembly 124 has a second outer cover 124a and a second inner cover 124b. The second outer cover 124a and the second inner cover 124b are connected to each other to jointly cover and hold the second host connecting end 112 and the second head strap connecting end 122. Therefore, the second strengthening assembly 124 provides structural reinforcement, so that the assembly connection between the second host connecting end 112 of the host 110 and the second head strap connecting end 122 of the head strap body 120a is more stable.

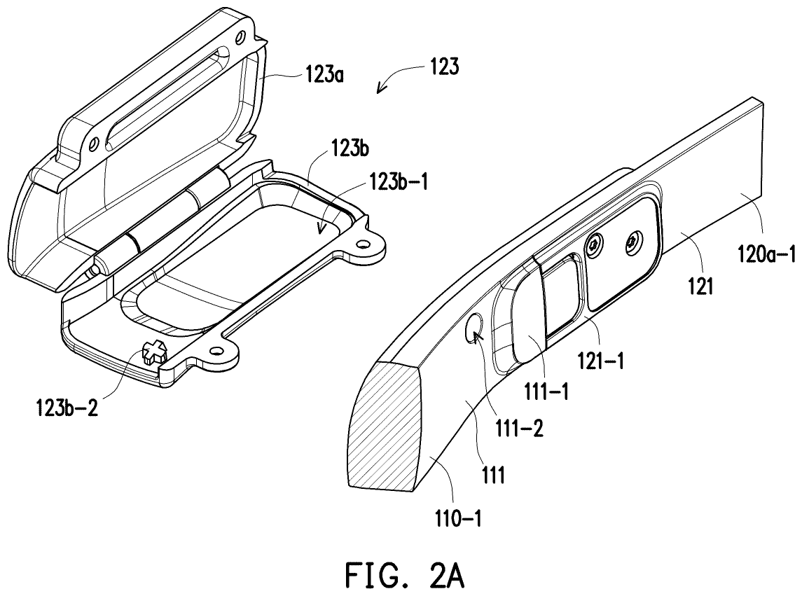

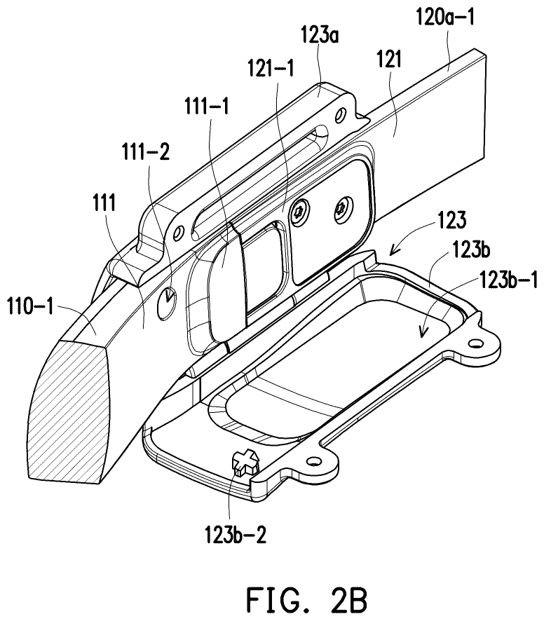

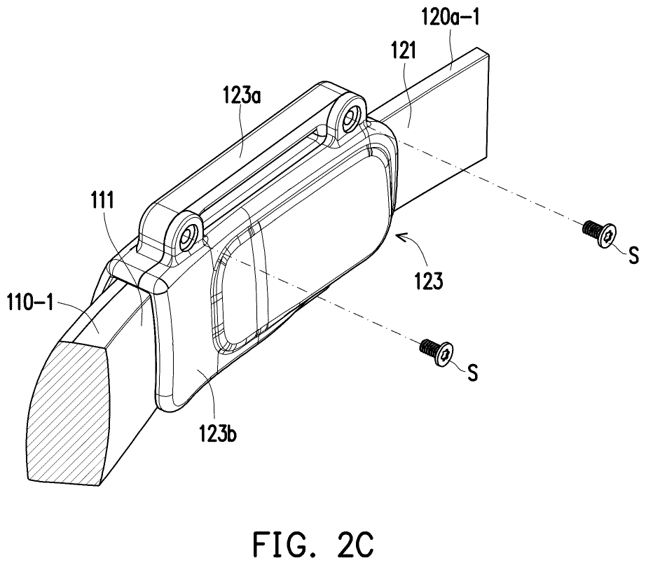

Please refer to FIG. 1C and FIG. 2A to FIG. 2C. In the present embodiment, a side of the first outer cover 123a may be pivotally connected to a side of the first inner cover 123b, so that the first outer cover 123a and the first inner cover 123b are opened to accommodate the first host connecting end 111 and the first head strap connecting end 121. Moreover, another side of the first outer cover 123a may be detachably connected (such as the locking of a screw S) to another side of the first inner cover 123b, so that the first outer cover 123a and the first inner cover 123b are closed to jointly cover and hold the first host connecting end 111 and the first head strap connecting end 121.

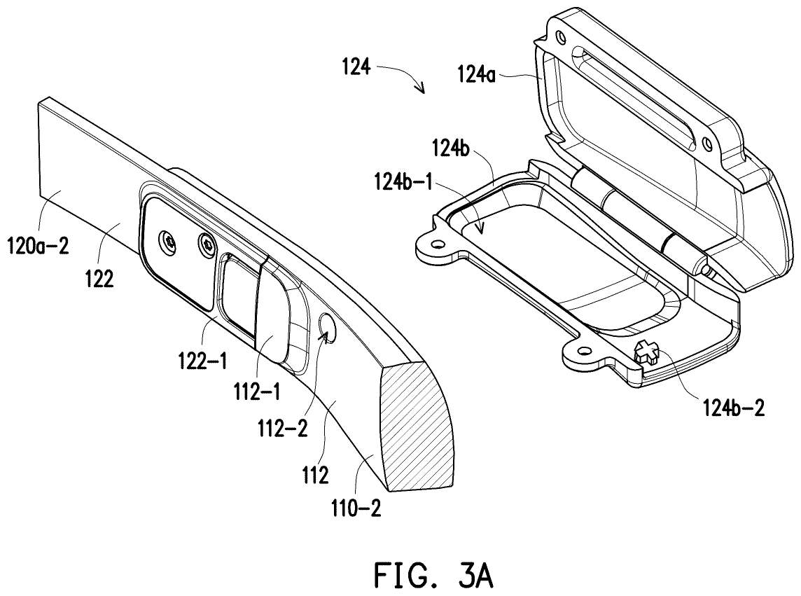

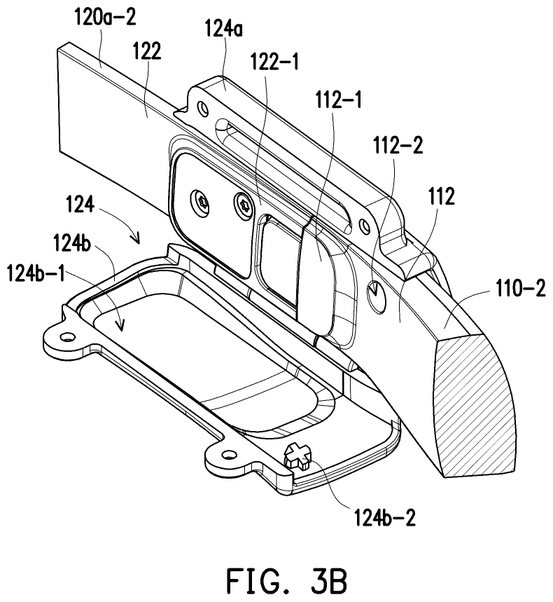

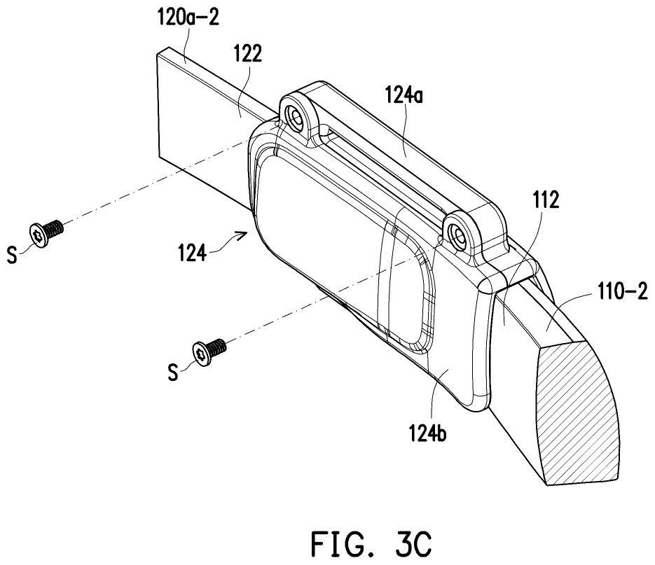

Please refer to FIG. 1C and FIG. 3A to FIG. 3C. In the present embodiment, a side of the second outer cover 124a may be pivotally connected to a side of the second inner cover 124b, so that the second outer cover 124a and the second inner cover 124b are opened to accommodate the second host connecting end 112 and the second head strap connecting end 122. Moreover, another side of the second outer cover 124a may be detachably connected (such as the locking of the screw S) to another side of the second inner cover 124b, so that the second outer cover 124a and the second inner cover 124b are closed to jointly cover and hold the second host connecting end 112 and the second head strap connecting end 122.

Please refer to FIG. 2A again. In the present embodiment, the first host connecting end 111 may have a first host protrusion 111-1. The first head strap connecting end 121 may have a first head strap protrusion 121-1. The first inner cover 123b may have a first assembly recess 123b-1 to cooperate with the first host protrusion 111-1 and the first head strap protrusion 121-1. In addition, the first host connecting end 111 may have a first alignment recess 111-2. The first inner cover 123b may have a first alignment protrusion 123b-2 to fit with the first alignment recess 111-2.

Please refer to FIG. 3A again. In the present embodiment, the second host connecting end 112 may have a second host protrusion 112-1. The second head strap connecting end 122 may have a second head strap protrusion 122-1. The second inner cover 124b may have a second assembly recess 124b-1 to cooperate with the second host protrusion 112-1 and the second head strap protrusion 122-1. In addition, the second host connecting end 112 may have a second alignment recess 112-2. The second inner cover 124b may have a second alignment protrusion 124b-2 to fit with the second alignment recess 112-2.

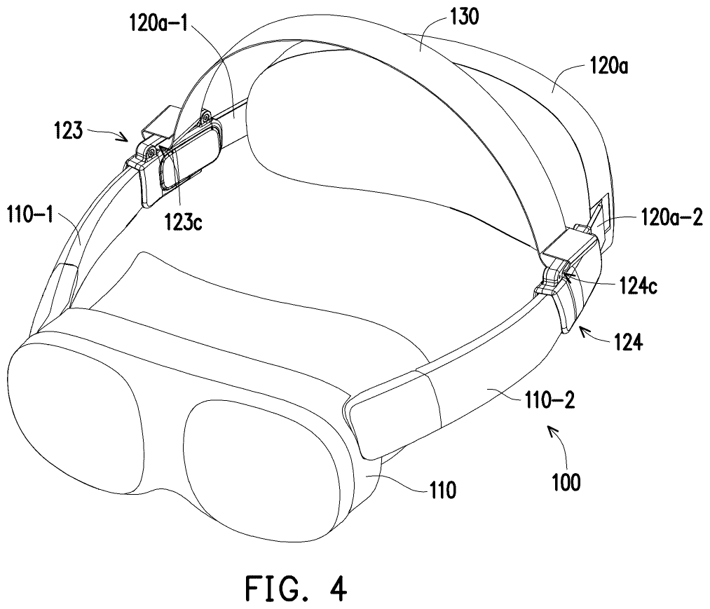

Please refer further to FIG. 1C and FIG. 4. In the present embodiment, the first strengthening assembly 123 may have a first strap hole 123c. The second strengthening assembly 124 may have a second strap hole 124c. The head strap module 120 may further include an upper head strap 130. Two opposite ends of the upper head strap 130 are respectively tied to the first strap hole 123c and the second strap hole 124c to provide auxiliary support.

Based on the above, in the above embodiments of the present application, the strengthening assemblies of the head strap module cover and hold the corresponding host connecting end and head strap connecting end, so that there is a more stable assembly connection between the host and the head strap module. In addition, the two opposite ends of the upper head strap may be tied to the strap holes of the two strengthening assemblies respectively to provide auxiliary support.

What is claimed is:

1. A wearable device, comprising:
a host, wherein two opposite sides thereof have a first host connecting end and a second host connecting end respectively; and
a head strap module, comprising:
a head strap body, wherein two opposite sides thereof have a first head strap connecting end and a second head strap connecting end respectively, and the first head strap connecting end and the second head strap connecting end are detachably assembled to the first host connecting end and the second host connecting end respectively;
a first strengthening assembly having a first outer cover and a first inner cover, wherein the first outer cover and the first inner cover are connected to each other to jointly cover and hold the first host connecting end and the first head strap connecting end; and
a second strengthening assembly having a second outer cover and a second inner cover, wherein the second outer cover and the second inner cover are connected to each other to jointly cover and hold the second host connecting end and the second head strap connecting end.

2. The wearable device of claim 1, wherein a side of the first outer cover is pivotally connected to a side of the first inner cover, so that the first outer cover and the first inner cover are opened to accommodate the first host connecting end and the first head strap connecting end, and another side of the first outer cover is detachably connected to another side of the first inner cover, so that the first outer cover and the first inner cover are closed to jointly cover and hold the first host connecting end and the first head strap connecting end.

3. The wearable device of claim 2, wherein a side of the second outer cover is pivotally connected to a side of the second inner cover, so that the second outer cover and the second inner cover are opened to accommodate the second host connecting end and the second head strap connecting end, and another side of the second outer cover is detachably connected to another side of the second inner cover, so that the second outer cover and the second inner cover are closed to jointly cover and hold the second host connecting end and the second head strap connecting end.

4. The wearable device of claim 1, wherein the first host connecting end has a first host protrusion, the first head strap connecting end has a first head strap protrusion, and the first inner cover has a first assembly recess to cooperate with the first host protrusion and the first head strap protrusion.

5. The wearable device of claim 4, wherein the second host connecting end has a second host protrusion, the second head strap connecting end has a second head strap protrusion, and the second inner cover has a second assembly recess to cooperate with the second host protrusion and the second head strap protrusion.

6. The wearable device of claim 1, wherein the first host connecting end has a first alignment recess, and the first inner cover has a first alignment protrusion to fit with the first alignment recess.

7. The wearable device of claim 6, wherein the second host connecting end has a second alignment recess, and the second inner cover has a second alignment protrusion to fit with the second alignment recess.

8. The wearable device of claim 1, wherein the first strengthening assembly has a first strap hole, the second strengthening assembly has a second strap hole, and the head strap module further comprises:
an upper head strap, wherein two opposite ends thereof are tied to the first strap hole and the second strap hole respectively.

9. The wearable device of claim 1, wherein two opposite sides of the host respectively have a first bracket and a second bracket, and ends of the first bracket and the second bracket serve as the first host connecting end and the second host connecting end respectively.

10. The wearable device of claim 1, wherein two opposite sides of the head strap body have a first strap body and a second strap body respectively, and ends of the first strap body and the second strap body serve as the first head strap connecting end and the second head strap connecting end respectively.

11. A head strap module, applied to a wearable device, wherein the wearable device comprises a host, two opposite sides of the host have a first host connecting end and a second host connecting end respectively, and the head strap module comprises:
a head strap body, wherein two opposite sides thereof have a first head strap connecting end and a second head strap connecting end respectively, and the first head strap connecting end and the second head strap connecting end are detachably assembled to the first host connecting end and the second host connecting end respectively;
a first strengthening assembly having a first outer cover and a first inner cover, wherein the first outer cover and the first inner cover are connected to each other to jointly cover and hold the first host connecting end and the first head strap connecting end; and
a second strengthening assembly having a second outer cover and a second inner cover, wherein the second outer cover and the second inner cover are connected to each other to jointly cover and hold the second host connecting end and the second head strap connecting end.

12. The head strap module of claim 11, wherein a side of the first outer cover is pivotally connected to a side of the first inner cover, so that the first outer cover and the first inner cover are opened to accommodate the first host connecting end and the first head strap connecting end, and another side of the first outer cover is detachably connected to another side of the first inner cover, so that the first outer cover and the first inner cover are closed to jointly cover and hold the first host connecting end and the first head strap connecting end.

13. The head strap module of claim 12, wherein a side of the second outer cover is pivotally connected to a side of the second inner cover, so that the second outer cover and the second inner cover are opened to accommodate the second host connecting end and the second head strap connecting end, and another side of the second outer cover is detachably connected to another side of the second inner cover, so that the second outer cover and the second inner cover are closed to jointly cover and hold the second host connecting end and the second head strap connecting end.

14. The head strap module of claim 11, wherein the first host connecting end has a first host protrusion, the first head strap connecting end has a first head strap protrusion, and the first inner cover has a first assembly recess to cooperate with the first host protrusion and the first head strap protrusion.

15. The head strap module of claim 14, wherein the second host connecting end has a second host protrusion, the second head strap connecting end has a second head strap protrusion, and the second inner cover has a second assembly recess to cooperate with the second host protrusion and the second head strap protrusion.

16. The head strap module of claim 11, wherein the first host connecting end has a first alignment recess, and the first inner cover has a first alignment protrusion to fit with the first alignment recess.

17. The head strap module of claim 16, wherein the second host connecting end has a second alignment recess, and the second inner cover has a second alignment protrusion to fit with the second alignment recess.

18. The head strap module of claim 11, wherein the first strengthening assembly has a first strap hole, the second strengthening assembly has a second strap hole, and the head strap module further comprises:
an upper head strap, wherein two opposite ends thereof are tied to the first strap hole and the second strap hole respectively.

19. The head strap module of claim 11, wherein two opposite sides of the head strap body have a first strap body and a second strap body respectively, and ends of the first strap body and the second strap body serve as the first head strap connecting end and the second head strap connecting end respectively.
